(19) United States
(12) Patent Application Publication
(10) Pub. No.: US 2005/0112955 A1
(43) Pub. Date: May 26, 2005

(54) PCB mountable staggered terminal block

(75) Inventors: Mark C. Buckley, Shingle Springs, CA (US); John M. Kovach, Shoreham, NY (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc., Morristown, NJ (US)

(21) Appl. No.: 10/719,291

(22) Filed: Nov. 21, 2003

(51) Int. Cl. H01R 4/38

(52) U.S. Cl. 439/727

(57) ABSTRACT

A terminal block for coupling at least one conductor to a printed circuit board with a housing of insulating material, at least two cavities in the housing for accepting screw-operated conductor clamping or insulation displacement terminals, the housing having a length-wise direction along a reference line, the two cavities each having a center point, with the center point of at least one of the two cavities disposed in an offset position from the reference line in the length-wise direction such that at least two cavities are staggered with respect to each other. The staggering enables a standard installer screwdriver with a ⅛ inch (3.175 mm) width blade to be used for the screw heads of a miniature terminal block. Remaining components of the terminal block such as the contact members and wire guards used in conventional terminal blocks can still be accommodated.

### BACKGROUND OF THE INVENTION

1. Field of Invention

The invention relates generally to the field of terminal blocks for printed circuit boards and, more specifically, to a terminal block with a housing arranged to enable the screw heads of the terminal block to be turned by a standard installer screwdriver.

2. Description of Related Art

Installers of electrical systems carry an industry standard flat blade screwdriver, also known as a pocket screwdriver. The blade width of this screwdriver is approximately ⅛ inch (3.175 mm). Electrical devices are electrically connected together with wires. These wires are connected to the circuit boards of electronic devices via terminal blocks. These terminal blocks contain screws which clamp down on the wires as the screws are tightened with these industry standard screw drivers. Electronic devices are getting smaller as the electronics industry advances. Miniature printed circuit board (PCB) mounted terminal blocks (3.5 mm centerline spacing) are being used more often in these smaller electronic devices. The industry standard screwdriver is too wide to be used with the small screws in the miniature terminal blocks. The screw head size in the current miniature terminal blocks can not be increased without interfering with the neighboring screw or increasing the length of the terminal block. The next size larger terminal block (5 mm centerline spacing) does accept the industry standard screw driver. However it is 43% longer, 10% wider and 18% taller. In many applications, the larger size terminal block can not be accommodated.

However, use of the smaller blade width screwdriver can result in inadequate torque and consequently in inadequate and poor quality electrical connections. As a result, use of the industry standard blade width screwdriver is strongly preferred by the installers.

What is needed is a smaller size terminal block to accommodate the trend to miniaturization of the electronic parts and which permits, at the same time, use of an industry standard blade width screwdriver to make the electrical connections.

### SUMMARY OF THE INVENTION

To address the above and other issues, the present invention describes a technique for staggering the screw cavities of a miniature terminal block to decrease the size of PCBs while, at the same time, permits use of an industry standard installer's screwdriver for all styles or types of PCB mounting arrangements.

In a particular aspect of the invention, a printed circuit board (PCB) has a terminal block for coupling by screw-operated coupling means at least one conductor to the PCB, the terminal block comprising: a housing of insulating material, the housing having at least one transverse opening capable of receiving at least one contact member for coupling the at least one conductor to the PCB, and at least two cavities disposed within the housing. The cavities are for accepting the screw-operated coupling means. The housing has a length-wise direction along a reference line, and the at least two cavities each has a center point. The center point of at least one of the at least two cavities is disposed in an offset position from the reference line in the length-wise direction such that the at least two cavities are staggered with respect to each other.

Another aspect of the present invention is a printed circuit board (PCB) mountable terminal block for coupling by screw-operated coupling means at least one conductor to a PCB. The terminal block comprises a housing. At least two cavities within the housing are for accommodating a screw of the screw-operated coupling means; and at least one transverse opening within the housing is capable of accommodating a contact member, the at least one transverse opening being capable of disposing the contact member on an end surface of the PCB such that the at least one conductor can be coupled to the PCB from the end surface. The housing has a length-wise direction along a reference line, the at least two cavities each having a center point, and the center point of at least one of the at least two cavities is disposed in an offset position from the reference line in the length-wise direction such that the at least two cavities are staggered with respect to each other.

Another aspect of the present invention is a printed circuit board (PCB) mountable terminal block for coupling by screw-operated coupling means at least one conductor to a PCB. The terminal block comprises a housing. At least two cavities within the housing are for accommodating a screw of a screw-operated coupling means; and at least one transverse opening within the housing is capable of accommodating a contact member. The housing has a length-wise direction along a reference line. The at least two cavities each has a center point, the center point of at least one of the at least two cavities being disposed in an offset position from the reference line in the length-wise direction such that the at least two cavities are staggered with respect to each other. The housing of the terminal block has a height enabling orientation of a length-wise direction of the terminal block transversely with respect to a longitudinal centerline direction of a larger housing enclosing the terminal block and the PCB

Still another aspect of the present invention is a terminal block for coupling by screw-operated coupling means for coupling at least one conductor to a printed circuit board. The terminal block comprises a housing of insulating material. The housing has at least one transverse opening capable of receiving at least one contact member for coupling the at least one conductor to the PCB, and at least two cavities are disposed within the housing. The cavities are for accepting the screw-operated coupling means. The housing has a length-wise direction along a reference line. The at least two cavities each has a center point. The center point of at least one of the at least two cavities is disposed in an offset position from the reference line in the length-wise direction such that the at least two cavities are staggered with respect to each other.

In each of the foregoing aspects of the present invention, at least one of the at least two cavities has a diameter at least equal to the width of the blade of a standard installer screwdriver. A contact member can be disposed within at least one of the at least two cavities. The contact member comprises: an upper portion with a transverse opening, and a lower portion with a pin, and wherein the upper portion is threaded to accept a screw. The contact member can further comprise a screw with a head having a diameter at least equal to the width of the blade of a standard installer screwdriver.

The diameter of the at least one of the at least two cavities is at least equal to 0.125 inches (3.175 mm). The head of the screw has a diameter at least equal to 0.125 inches (3.175 mm). The contact member can further comprise a wire guard for guarding a conductor wire. The lower portion with a pin can be disposed to permit through hole mounting to a printed circuit board (PCB). The terminal block can comprise solder pads permitting surface mounting to a printed circuit board (PCB). The terminal block can be for coupling by screw-operated conductor-clamping terminal coupling means for coupling at least one conductor to a printed circuit board. Alternatively, the terminal block is for coupling by screw-operated insulation displacement terminal coupling means for coupling at least one conductor to a printed circuit board. The housing can comprise at least four transverse openings that can be disposed on an end surface of the PCB, the openings each capable of accommodating at least one contact member for coupling a conductor to the PCB.

When the housing of the terminal block has a height enabling orientation of a length-wise direction of said terminal block transversely with respect to a longitudinal centerline direction of a larger housing enclosing the terminal block and the PCB, the larger housing can have an inner diameter of 1 inch (25.4 mm).

### BRIEF DESCRIPTION OF THE DRAWINGS

These and other features, benefits and advantages of the present invention will become apparent by reference to the following text and figures, with like reference numbers referring to like structures across the views, wherein:

FIG. 1A shows a perspective view of a PCB mount terminal block of the prior art.

FIG. 1B shows a perspective view of a PCB mount staggered terminal block of the present invention.

FIG. 2A shows a perspective view of the prior art terminal block of FIG. 1A with respect to a standard installer screwdriver blade.

FIG. 2B shows a perspective view of the terminal block of the present invention of FIG. 1B with respect to the standard installer screwdriver blade.

FIG. 3A shows a perspective view of the prior art terminal block with the components fully assembled.

FIG. 3B shows a perspective view of the terminal block of the present invention with the components fully assembled.

FIG. 4A is an exploded perspective view of the prior art terminal block.

FIG. 4B is an exploded perspective view of the terminal block of the present invention.

FIG. 5A-1 is a plan view of the prior art terminal block.

FIG. 5A-2 is an elevation view of the prior art terminal block.

FIG. 5A-3 is a side elevation view of the prior art terminal block.

FIG. 5B-1 is a plan view of the terminal block of the present invention.

FIG. 5B-2 is an elevation view of the terminal block of the present invention.

FIG. 5B-3 is a side elevation view of the terminal block of the present invention.

### DETAILED DESCRIPTION OF THE INVENTION

The present invention describes a terminal block structure in which by alternately shifting each screw fore or aft (staggering), larger screw head diameters can be accommodated without increasing the length of the terminal block. The screw heads can be enlarged sufficiently to accept at least the ⅛″ (3.175 mm) wide industry standard screwdriver or greater. The front face of the wire receptacle is recessed within the nonconductive housing to prevent the exposed uninsulated portions of neighboring wires from contacting each other. By staggering the screws and associated wire receptacles, the same effect is achieved without increasing the width of the miniature terminal block. Therefore, within the same PCB foot-print used by a current miniature PCB mountable terminal block, this invention provides the installer a terminal block which will accept the industry standard screwdriver, and so result in high quality electrical connections even with reduced size terminal blocks.

This invention can be used in any application that currently employs a miniature PCB mountable terminal block and will provide the benefit of working with a larger range of screwdrivers. Although the embodiment of this invention shown in the attached illustrations contains pins for a “through hole” PCB attachment, an alternate embodiment can be made in a surface mount (SMD) configuration.

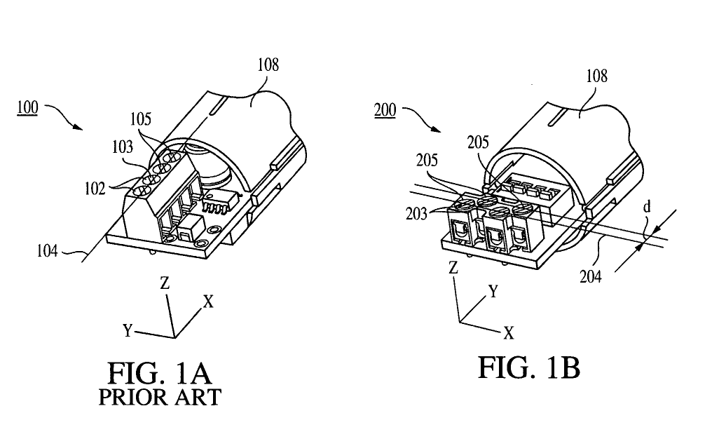

FIG. 1A shows a perspective view of a PCB-mountable staggered terminal block of the prior art. The three-dimensional x-y-z axes are as shown. The x and y axes lie in the plane of the PCB with the x-axis oriented along the length of the terminal block and the z-axis normal to the plane of the PCB. Terminal block 100 is configured such that screw heads 102 are positioned in cavities 103. The cavities 103 each have a center point 105, which coincides with the center point of the screw heads 102. The center points 105 are positioned linearly along a reference line 104 that is parallel to the x-axis. The terminal block 100 is shown here mounted on a PCB which projects from a nonconductive housing 108. The nonconductive housing 108 illustrated is a typically 1 inch (25.4 mm) diameter enclosure, which protects the printed circuit board assembly of an acoustic glass-break detector. It can be appreciated from FIG. 1A that the 3.5 mm centerline spacing terminal block 104 shown does fit within the 1 inch (25.4 mm) diameter enclosure 108. It can be appreciated that a larger 5 mm centerline spacing terminal block which accepts the industry standard blade width screw driver would violate the 1 inch (25.4 mm) diameter enclosure. It is the small size of the enclosure that limits the size of the PCB assembly and creates the need for small terminal blocks. Small enclosures such as enclosure 108 in various form factors are commonly used for many electronic devices coupled to wires in a building driving the need for smaller terminal blocks, for example, such as a residential, commercial or industrial building security sensors and user interface panels; or for heating, ventilating and air-conditioning (HVAC) systems; or for machine control systems, or for smoke or fire detection systems.

FIG. 1B shows a perspective view of a PCB mountable staggered terminal block of the present invention. The three-dimensional x-y-z axes are as shown. The x and y axes lie in the plane of the PCB with the x-axis oriented along the length of the terminal block and the z-axis normal to the plane of the PCB. Terminal block 200 is configured such that screw heads 202 are positioned in cavities 203 along a reference line 204 that is parallel to the x-direction. Similarly, the cavities 203 each have a center point 205 which coincides with the center point of the screw heads 202. However, center points 205 of the screw heads 202 are staggered by offsets in the y-direction with respect to the reference line 204 in the x-axis direction. The reduced height combined with the staggered configuration of the terminal block 200 enables it to be readily inserted into the nonconductive housing 108 in an orientation such that the length-wise direction of the terminal block is parallel to the x-axis. This orientation is more convenient for the installer who must connect the wires since the wires can now be inserted from the end of the PCB rather than from the side. That is, the prior art terminal block 100 will not fit in the 1 inch diameter housing if rotated 90° to provide better wire installation access.

In addition, when a sensor package is mounted and recessed into a cavity in a wall, an end mounted terminal block provides much greater advantages to the installer since the wires can be inserted from the end of the PCB rather than from the side. In the present invention, four terminals are possible in an end mounted configuration, and less depth of the recess cavity is required as compared to the prior art.

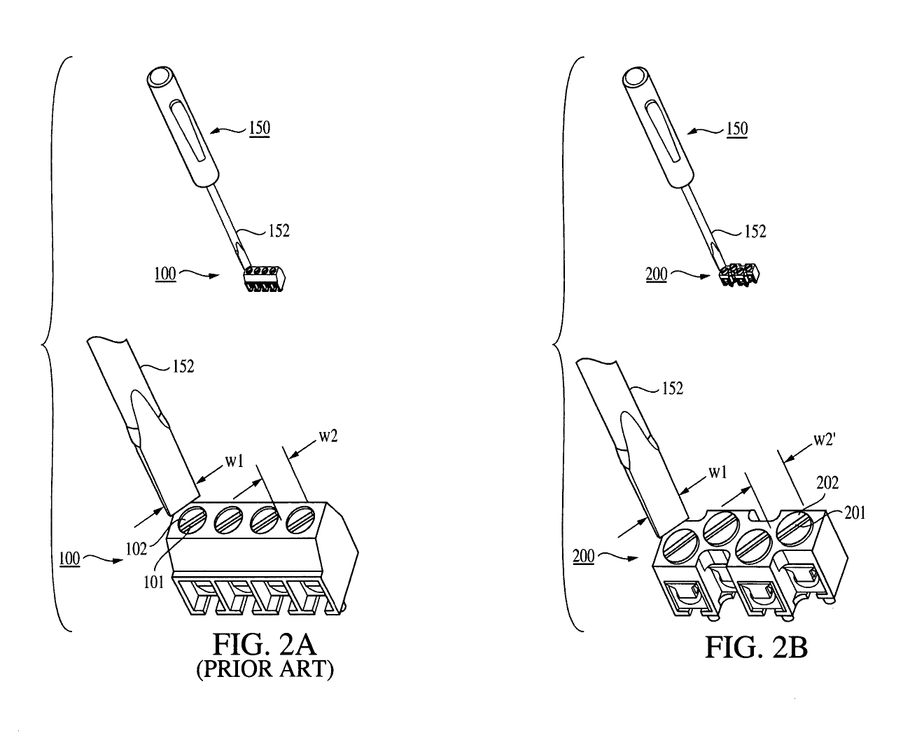

FIG. 2A shows a perspective view of the prior art terminal block 100 of FIG. 1A with respect to a standard installer screwdriver 150 with a ⅛ inch (3.175 mm) wide blade 152. The width w1 of the screwdriver blade 152 is greater than the width w2 of the screw heads 102. The width w2 typically corresponds to the width of the slots 101. Therefore, it is necessary for the installer to use a special screwdriver with a blade designed for the width w2 of the miniature screw heads 102.

FIG. 2B shows a perspective view of the terminal block 200 of the present invention of FIG. 1B with respect to the standard installer screwdriver 150 with a ⅛ inch (3.175 mm) wide blade 152. In this case, the width w1 of the screwdriver blade 152 is less than or equal to the width w2′ of the screw heads 202. The staggered positions of the screw heads 202 enable the screw heads 202 to have a width w2′ that is at least equal to and typically greater than the width w1 of the screwdriver blade 152. Therefore, the installer can now use the standard screwdriver 150 with a blade 152 because the width w1 of the screwdriver blade 152 is now less than or equal to the width w2′ of the slot 201 of the screw heads 202. Those skilled in the art recognize that the width w2′ of the screw heads 202 enable usage also of screwdrivers with blade widths less than that of a ⅛ inch (3.175 mm) wide standard installer screwdriver.

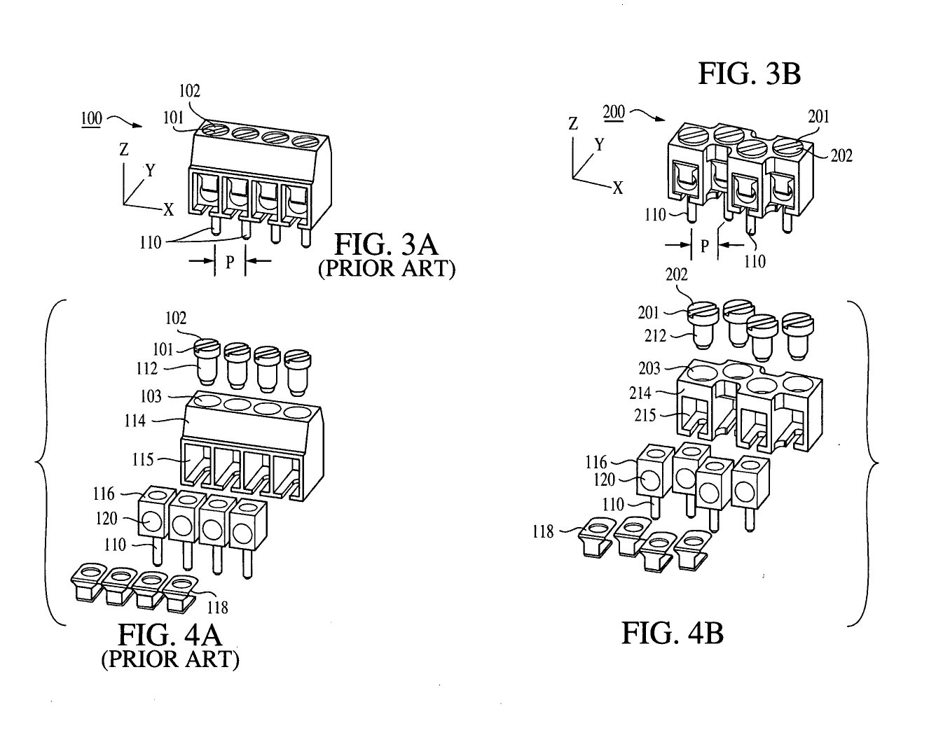

FIG. 3A shows a perspective view of the prior art terminal block 100 with the components fully assembled. As noted previously, the screw heads 102 are shown with a slot 101. The slot 101 is typically 0.108 inches (2.7 mm) long and corresponds to the width w2. The spacing interval or pitch p between contact pins 110 in the x-direction is typically 0.138 inches (3.5 mm).

FIG. 3B shows a perspective view of the terminal block 200 of the present invention with the components fully assembled. The screw heads 202 are shown with a slot 201 that corresponds to the width w2′. The slot 201 is typically 0.134 inch (3.4 mm) long. The spacing interval or pitch p between the contact pins 110 is also typically 0.138 inches (3.5 mm) in the x-direction, yet staggered 0.075 inches (1.9 mm) in the y direction.

FIG. 4A is an exploded perspective view of the prior art terminal block 100, with the screws 112, the terminal block housing 114, transverse openings 115, contacts 116 with pins or leads 110 and the wire guards 118. The contacts 116 are accommodated within the transverse openings 115 of the terminal block housing 114. A transverse opening 120 in each contact 116 enables the contact to accommodate one or more conductors (not shown). The screws 112 acting together with the contacts 116 with pins or leads 110 and the wire guards 118 form a screw-operated conductor clamping terminal means for clamping the conductors that are positioned within the transverse openings 120. A conductive electrical path is formed from the conductors to the pins or leads 110 of the contacts 116. The wire guards 118 act like washers by protecting the conductor wires from the rotation of the screw as the screws 112 clamp down on the wires.

FIG. 4B is an exploded perspective view of the terminal block 200 of the present invention, which enables incorporation of the same wire guards 118 and the contacts 116 with pins or leads 110 and transverse openings 120. However, the terminal block housing 214 is configured in a staggered arrangement by offsets in the y-direction along the x-axis to accommodate the screws 212. The screws 212 have heads 202 as described previously with the slot 201 being typically a 0.134 inch (3.4 mm) long slot that corresponds to the width w2′. The screws 212 provide the same screw-operated means for clamping conductors as described for the screws 112 in FIG. 4A. The same contacts 116 are accommodated within the transverse openings 215 of the terminal block housing 214.

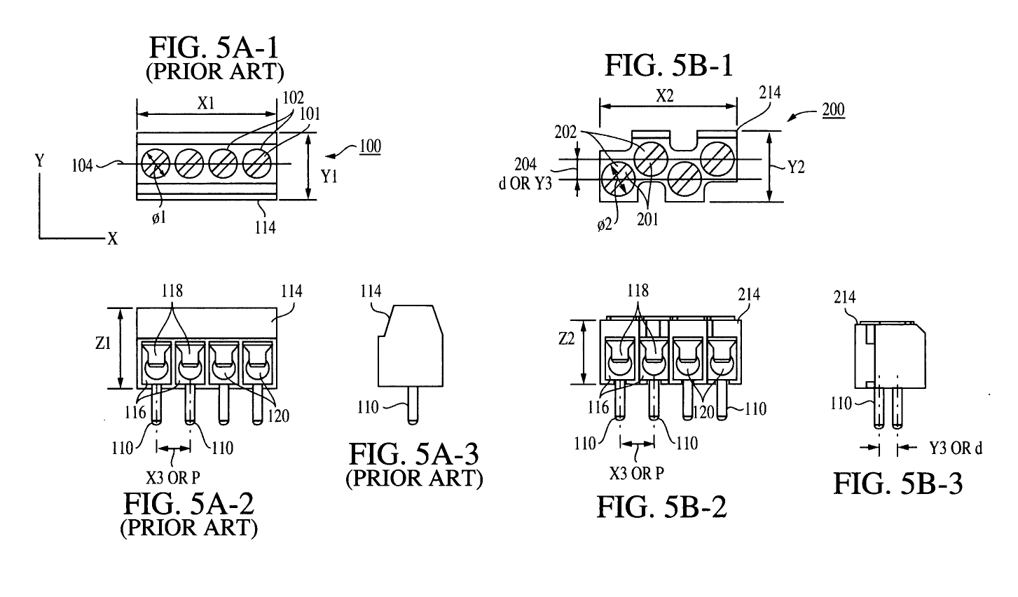

FIG. 5A-1 is a plan view of the prior art terminal block 100 showing the housing 114 and the screw heads 102. The screw heads 102 are configured to have a zero offset with respect to the x-direction reference line 104 and have a diameter Φ1. The diameter Φ1 corresponds typically to width w2 of FIG. 2A, and is typically 0.108 inches (2.7 mm). The dimension Y1 is the depth of the housing 114, which is typically 0.270 inches (6.9 mm). The dimension X1 is the length of the housing 114, which is typically 0.572 inches (14.5 mm).

FIG. 5B-1 is a plan view of the terminal block 200 showing the housing 214 and the screw heads 202. In this case, the screw heads 202 are configured to have at least one offset d in the y-direction, i.e., d=Y3, with respect to the x-direction reference line 204 and have a diameter φ2. Typically, the diameter φ2 corresponds to w2′ of FIG. 2B, and typically is 0.134 inches (3.4 mm). The dimension Y2 is the depth of the housing 214. Despite the offset d=Y3 and the larger diameter φ2 as compared to φ1, Y2 is only 0.275 inches (7.0 mm). The dimension X2 is the length of the housing 214. Despite the offset and the larger diameter φ2 as compared to φ1, X2 is only 0.576 inches (14.6 mm). As a result, the “foot-print” or area A2 formed by the dimensions X2×Y2, i.e., 0.15840 in² (102.19 mm²), is virtually equal to the area A1 formed by the dimensions X1×Y1, i.e., 0.15444 in² (99.64 mm²), so despite the staggering of the cavities 203, the foot-print remains virtually the same as in the prior art. In addition, terminal blocks that employ other types of screws such as, for example, Phillips head or Allen wrench head type screws, can also be arranged with staggered screw cavities as shown. Correspondingly, the diameter of such screw heads and of their respective screwdriver blades or wrench teeth can be larger than permissible with the prior art configuration of the terminal blocks while maintaining essentially the same footprint.

FIG. 5A-2 is an elevation view of the prior art terminal block 100 showing the housing 114 having a height dimension Z1. FIG. 5A-3 is a side elevation view of the terminal block 100 showing the housing 114 of the prior art. Typically, Z1 is 0.335 inches (8.5 mm). The spacing interval X3 or pitch p between the contact pins 110 is typically 0.138 inches (3.5 mm).

FIG. 5B-2 is an elevation view of the terminal block 200 of the present invention showing the housing 214 having a height dimension Z2. FIG. 5B-3 is a side elevation view of the terminal block 200 showing the housing 214 of the present invention.

In the present invention, due to the removal of the recessed screw retention features at the top of the screw cavities 203, Z2 typically is only 0.261 inches (6.6 mm). The spacing interval X3 or pitch p between the contact pins 110 can remain the same as in the prior art, and is typically 0.138 inches (3.5 mm).

In a terminal block embodiment of the present invention, which contains typical screw retention features, the height Z2 would remain the same as the prior art, i.e., Z1=Z2. These retention features typically take the form of deeper counterbores in the housing which have a slight interference fit with the screw heads. These counterbores are typically of sufficient length to maintain interference with the screw heads when the screws threads are completely disengaged from the contacts, thereby preventing the screws from being removed inadvertently.

By removing the screw retention features, the terminal block 200 affords a lower profile, as exemplified by dimension Z2, as compared to dimension Z1 of the terminal block 100, i.e., 0.261 in. (6.6 mm) as compared to 0.335 in. (8.5 mm). The lower profile affords additional degrees of freedom in orienting the terminal block 200 with respect to the nonconductive housing 108. This is exemplified in FIG. 1B where the longitudinal direction, i.e., the x-direction, of the terminal block 200 is oriented transversely with respect to the centerline longitudinal axis of the cylindrical non-conductive housing 108. Therefore, the terminal block 200 is oriented 90° with respect to the terminal block 100 of the prior art as shown in FIG. 1A.

The prior art terminal block 100 in FIG. 1A must be oriented with the length-wise axis parallel to the axis of the cylindrical housing 108 since it will not fit within the housing if rotated 90°. The disadvantage of this orientation is that an installer must insert the conductor wires into the terminal block receptacles over the top of other PCB mounted components, which makes the installation difficult. In the sensor housing shown in FIG. 1B, the conductor wires are easily accessible. By eliminating the screw retention features, it becomes possible therefore to orient the terminal block 200 as shown in FIG. 1B to make the conductor wires easily accessible.

The typical dimensions of a terminal block both the prior art and of the present invention are shown in the table which follows below.

| | |
|---|---|
| TYPICAL DIMENSIONS | TYPICAL DIMENSIONS |
| PRIOR ART | PRESENT INVENTION |

| Dimension | in. | mm | Dimension | in. | mm |
|---|---|---|---|---|---|
| X1 | 0.572 | 14.5 | X2 | 0.576 | 14.6 |
| X3 (=p) | 0.138 | 3.5 | X3 (=p) | 0.138 | 3.5 |
| Y1 | 0.270 | 6.9 | Y2 | 0.275 | 7.0 |
| Y3 | 0 | 0 | Y3 | 0.075 | 1.9 |
| φ1 (or w2) | 0.108 | 2.7 | φ2 (or w2′) | 0.134 | 3.4 |
| A1 = | 0.15444 | 100.05 | A2 = | 0.1580 | 102.20 |
| X1 × Y1 | in² | mm² | X2 × Y2 | in² | mm² |
| Z1 | 0.335 | 8.5 | Z2 | 0.261 | 6.6 |

Those skilled in the art recognize that the dimensions of X2, Y2, Z2 and offsets represented by Y3 (=d) are not limited and can be varied as desired. Similarly, the spacing interval or pitch X3 (=p) can also be varied as desired.

Although the contacts 116 described in FIGS. 1B through 5B-3 for the present invention include pins 110 for a “through hole” PCB attachment, an alternate embodiment can be configured for a surface mount (SMD) configuration. In such a case, terminal block 200 includes solder pads (not shown) permitting surface mounting to a printed circuit board (PCB).

Those skilled in the art recognize that the screw-operated coupling means for clamping a conductor as discussed for FIGS. 4A and 4B are used with wire conductors which typically have approximately the last 0.25 inches (6.4 mm) of insulation removed prior to inserting the conductor into the terminal block receptacle. An alternate embodiment (not shown) is a screw-operated insulation displacement terminal coupling means in which the conductor ends are not stripped, and the lower ends or terminals of the screws 212 pierce or displace the conductor insulation making contact with the conductor wire.

The invention has been described herein with reference to particular exemplary embodiments. Certain alterations and modifications may be apparent to those skilled in the art, without departing from the scope of the invention. The exemplary embodiments are meant to be illustrative, not limiting of the scope of the invention, which is defined by the appended claims.

1. A printed circuit board (PCB) having a terminal block for coupling by screw-operated coupling means at least one conductor to said PCB, said terminal block comprising:
a housing of insulating material, said housing having at least one transverse opening capable of receiving at least one contact member for coupling the at least one conductor to said PCB, and
at least two cavities disposed within said housing, said cavities for accepting the screw-operated coupling means, said housing having a length-wise direction along a reference line, said at least two cavities each having a center point, said center point of at least one of said at least two cavities disposed in an offset position from the reference line in the length-wise direction such that said at least two cavities are staggered with respect to each other.

2. The PCB according to claim 1, wherein at least one of said at least two cavities of said terminal block has a diameter at least equal to the width of the blade of a standard installer screwdriver.

3. The PCB according to claim 1, further comprising at least one contact member disposed within said at least one transverse opening of said housing of said terminal block, said contact member comprising:
an upper portion with a transverse opening, and
a lower portion with a pin, and wherein said upper portion is threaded to accept a screw.

4. The PCB according to claim 3, wherein said contact member further comprises a screw with a head having a diameter at least equal to the width of the blade of a standard installer screwdriver.

5. The PCB according to claim 2, wherein the diameter of said at least one of said at least two cavities is at least equal to 0.125 inches (3.175 mm).

6. The PCB according to claim 4, wherein said head has a diameter at least equal to 0.125 inches (3.175 mm).

7. The PCB according to claim 3, wherein said contact member further comprises a wire guard for guarding a conductor wire.

8. The PCB according to claim 3, wherein said lower portion with a pin is disposed to permit through hole mounting to said PCB.

9. The PCB according to claim 1, wherein said terminal block comprises solder pads permitting surface mounting to a printed circuit board (PCB).

10. The PCB according to claim 1, wherein said terminal block is for coupling by screw-operated conductor-clamping terminal coupling means for coupling at least one conductor to said printed circuit board.

11. The PCB according to claim 1, wherein said terminal block is for coupling by screw-operated insulation displacement terminal coupling means for coupling at least one conductor to a printed circuit board.

12. A printed circuit board (PCB) mountable terminal block for coupling by screw-operated coupling means at least one conductor to a PCB,
said terminal block comprising:
a housing;
at least two cavities within said housing for accommodating a screw of said screw-operated coupling means; and
at least one transverse opening within said housing capable of accommodating a contact member, said at least one transverse opening capable of disposing the contact member on an end surface of the PCB such that the at least one conductor can be coupled to the PCB from the end surface,
said housing having a length-wise direction along a reference line, said at least two cavities each having a center point, said center point of at least one of said at least two cavities disposed in an offset position from the reference line in the length-wise direction such that said at least two cavities are staggered with respect to each other.

13. The terminal block according to claim 12, wherein said housing comprises at least four transverse openings that can be disposed on an end surface of the PCB, said openings each capable of accommodating at least one contact member for coupling a conductor to the PCB.

14. The terminal block according to claim 12, wherein at least one of said at least two cavities of said terminal block has a diameter at least equal to the width of the blade of a standard installer screwdriver.

15. The terminal block according to claim 12, wherein at least one contact member is disposed within said at least one transverse opening of said housing of said terminal block, said contact member comprising:
an upper portion with a transverse opening, and
a lower portion with a pin, and wherein said upper portion is threaded to accept a screw.

16. The terminal block according to claim 15, wherein said contact member further comprises a screw with a head having a diameter at least equal to the width of the blade of a standard installer screwdriver.

17. The terminal block according to claim 14, wherein the diameter of said at least one of said at least two cavities is at least equal to 0.125 inches (3.175 mm).

18. The terminal block according to claim 16, wherein said head has a diameter at least equal to 0.125 inches (3.175 mm).

19. The terminal block according to claim 15, wherein said contact member further comprises a wire guard for guarding a conductor wire.

20. The terminal block according to claim 15, wherein said lower portion with a pin is disposed to permit through hole mounting to said PCB.

21. The terminal block according to claim 12, wherein said terminal block comprises solder pads permitting surface mounting to the PCB.

22. The terminal block according to claim 12, wherein said terminal block is for coupling by screw-operated conductor-clamping terminal coupling means for coupling at least one conductor to said printed circuit board.

23. The terminal block according to claim 12, wherein said terminal block is for coupling by screw-operated insulation displacement terminal coupling means for coupling at least one conductor to a printed circuit board.

24. A printed circuit board (PCB) mountable terminal block for coupling by screw-operated coupling means at least one conductor to a PCB, said terminal block comprising:
a housing;
at least two cavities within said housing for accommodating a screw of said screw-operated coupling means; and
at least one transverse opening within said housing capable of accommodating a contact member,
said housing having a length-wise direction along a reference line, said at least two cavities each having a center point, said center point of at least one of said at least two cavities disposed in an offset position from the reference line in the length-wise direction such that said at least two cavities are staggered with respect to each other, said housing of said terminal block having a height enabling orientation of a length-wise direction of said terminal block transversely with respect to a longitudinal centerline direction of a larger housing enclosing said terminal block and the PCB.

25. The terminal block according to claim 24, wherein said housing of said terminal block comprises at least four transverse openings that can be disposed on an end surface of the PCB, said openings each capable of accommodating said at least one contact member for coupling a conductor to the PCB.

26. The terminal block according to claim 24, wherein at least one of said at least two cavities of said terminal block has a diameter at least equal to the width of the blade of a standard installer screwdriver.

27. The terminal block according to claim 24, wherein at least one contact member is disposed within said at least one transverse opening of said housing of said terminal block, said contact member comprising:
an upper portion with a transverse opening, and
a lower portion with a pin, and wherein said upper portion is threaded to accept a screw.

28. The terminal block according to claim 27, wherein said contact member further comprises a screw with a head having a diameter at least equal to the width of the blade of a standard installer screwdriver.

29. The terminal block according to claim 26, wherein the diameter of said at least one of said at least two cavities is equal to 0.125 inches (3.175 mm).

30. The terminal block according to claim 28, wherein said head has a diameter at least equal to 0.125 inches (3.175 mm).

31. The terminal block according to claim 27, wherein said contact member further comprises a wire guard for guarding a conductor wire.

32. The terminal block according to claim 27, wherein said lower portion with a pin is disposed to permit through hole mounting to said PCB.

33. The terminal block according to claim 24, wherein said terminal block comprises solder pads permitting surface mounting to the PCB.

34. The terminal block according to claim 24, wherein said terminal block is for coupling by screw-operated conductor-clamping terminal coupling means for coupling at least one conductor to the printed circuit board.

35. The terminal block according to claim 24, wherein said terminal block is for coupling by screw-operated insulation displacement terminal coupling means for coupling at least one conductor to the printed circuit board.

36. The terminal block according to claim 24, wherein said housing of said terminal block has a height enabling orientation of a length-wise direction of said terminal block transversely with respect to a longitudinal centerline direction of a larger housing enclosing said terminal block and the PCB, said larger housing having an inner diameter of 1 inch (25.4 mm).

37. A terminal block for coupling by screw-operated coupling means for coupling at least one conductor to a printed circuit board (PCB), said terminal block comprising:
a housing of insulating material, said housing having at least one transverse opening capable of receiving at least one contact member for coupling the at least one conductor to the PCB; and
at least two cavities disposed within said housing, said cavities for accepting the screw-operated coupling means, said housing having a length-wise direction along a reference line, said at least two cavities each having a center point, said center point of at least one of said at least two cavities disposed in an offset position from the reference line in the length-wise direction such that said at least two cavities are staggered with respect to each other.

38. The terminal block according to claim 37, wherein at least one of said at least two cavities has a diameter at least equal to the width of the blade of a standard installer screwdriver.

39. The terminal block according to claim 37, further comprising a contact member disposed within at least one of said at least two cavities, said contact member comprising:
an upper portion with a transverse opening, and
a lower portion with a pin, and wherein said upper portion is threaded to accept a screw.

40. The terminal block according to claim 39, wherein said contact member further comprises a screw with a head having a diameter at least equal to the width of the blade of a standard installer screwdriver.

41. The terminal block according to claim 38, wherein the diameter of said at least one of said at least two cavities is at least equal to 0.125 inches (3.175 mm).

42. The terminal block according to claim 40, wherein said head has a diameter at least equal to 0.125 inches (3.175 mm).

43. The terminal block according to claim 39, wherein said contact member further comprises a wire guard for guarding a conductor wire.

44. The terminal block according to claim 39, wherein said lower portion with a pin is disposed to permit through hole mounting to a printed circuit board (PCB).

45. The terminal block according to claim 37, wherein said terminal block comprises solder pads permitting surface mounting to a printed circuit board (PCB).

46. The terminal block according to claim 37, wherein said terminal block is for coupling by screw-operated conductor-clamping terminal coupling means for coupling at least one conductor to a printed circuit board.

47. The terminal block according to claim 37, wherein said terminal block is for coupling by screw-operated insulation displacement terminal coupling means for coupling at least one conductor to a printed circuit board.

48. The terminal block according to claim 37, wherein said housing comprises at least four transverse openings that can be disposed on an end surface of the PCB, said openings each capable of accommodating at least one contact member for coupling a conductor to the PCB.
